(19) United States
(12) Patent Application Publication
(10) Pub. No.: US 2009/0264550 A1
(43) Pub. Date: Oct. 22, 2009

(54) MANUFACTURING METHOD OF A MEMBRANE AND A MEMBRANE THEREOF, FOR EMULSIFICATION

(76) Inventor: Marilyn Rayner, Lund (SE)

Correspondence Address: Capitol City TechLaw, PLLC, PO BOX 1210, VIENNA, VA, 22183, US

(21) Appl. No.: 12/301,045

(22) PCT Filed: May 16, 2007
(86) PCT No.: PCT/SE07/00490

§ 371 Date: Nov. 17, 2008

(30) Foreign Application Priority Data
May 18, 2006 (SE) 0601132-4

(51) Int. Cl. C08G 64/40

(52) U.S. Cl. 521/189

(57) ABSTRACT

A manufacturing method of a membrane, a membrane obtained therefrom, and a use of said membrane for membrane emulsification. A desired shape of the membrane pores for spontaneous interfacial tension driven droplet formation is achieved by stretching the membrane material containing pores with a first shape, such that a second shape, i.e. the pores having an aspect ratio greater or equal to 3, is obtained.

### FIELD OF THE INVENTION

This invention pertains in general to the field of Membrane Emulsification. More particularly the invention relates to a method for manufacturing a membrane for membrane emulsification, a membrane obtained by said method, and emulsions obtained by the use of said membranes.

### BACKGROUND OF THE INVENTION

Emulsions are important commercial products in the food, cosmetic, and pharmaceutical industries. Emulsions consist of two or more immiscible phases, such as oil and water, or water and air, where a dispersed phase is suspended in a continuous phase, in the form of small droplets. Many of the most significant properties of emulsion-based products, such as shelf life, appearance, texture, flavour, encapsulation degree, and release rate are determined by the size of the droplets they contain. The size and the size distribution of droplets is the key to the stability of an emulsion, as it determines the rate of coalescence and its fitness for intended use.

Conventional emulsification methods (such as high pressure homogenisers, mixers, colloid mills, and ultrasonic emulsifiers) use mechanical energy to disperse immiscible fluids by brute force. Often a coarse mixture of droplets are converted into many more smaller droplets. The power dissipated in conventional commercial emulsification equipment is two or three orders of magnitude greater than that which is required to create the additional droplet interface. This means that generally over 99% of the energy is converted to heat rather than work causing a temperature rise in the liquid. Unless one uses very high energy density the resulting droplet size distributions are poly-dispersed. Microfluidizer devices, which generate narrower droplet size distributions, work at extremely high pressures (3000 bars).

An alternative emulsification technology of specific interest during the past decade for making emulsions is Membrane Emulsification (ME), which was introduced by Nakashima et al. in 1991. This process utilizes ceramic micro porous membranes, where the continuous phase flows tangentially to the membrane surface and the dispersed phase is pressed through the membrane. Droplets of the dispersed phase are formed at the openings of membrane pores, and are continuously swept away by the flowing continuous phase. The key feature of the ME process, which sets it apart from conventional emulsification technologies, is that the size distribution of the resulting droplets is primarily governed by the choice of membrane, rather than the development of turbulent, shearing, or extensional droplet break up (Peng and Williams, 1998). Hydrophilic membranes are used in making oil-in-water (O/W) emulsions, and hydrophobic membranes are used in making water-in-oil (W/O) emulsions. The dispersed phase should not wet the membrane surface. Advantages of ME are the possibility to produce droplets of defined size with narrow size distribution, low shear stresses, gentle processing conditions, and the potential for significantly lower energy consumption.

It has for example been shown that the membrane method proved more useful for encapsulating low molecular weight drugs since drug release rate was slower and encapsulation more effective. Okochi, H and Nakano, M (1997) “Comparative study of two preparation methods of w/o/w emulsions: stirring and membrane emulsification”, Chemical and Pharmaceutical Bulletin 45 (8): 1323-1326, showed that particles prepared by the stirring methods were less homogenous, where as particles prepared by membrane emulsification had a sharp, close to mono-disperse size distribution where the mean size was determined by the pore size of the membrane. The experiment was performed with water-in-oil-in-water (w/o/w) emulsions to encapsulate cytarabine, doxorubicin, and vancomycin.

Also, Sotoyama K, et al. (1999) “Water in oil emulsions prepared by the membrane emulsification method and their stability” Journal of Food Science 64 (2): 211-215, produced a w/o emulsions with a high water content. In comparison with emulsions using stirring methods, variations in droplet size and viscosity of emulsions prepared by membrane emulsification were small and the emulsions were more stable. It was also noted that droplet size was not related to the stability of these emulsions prepared by the membrane emulsification.

There are two basic mechanisms identified in the literature as to how droplets detach from membrane pores, shear induced droplet detachment and interfacial tension induced droplet detachment. In conventional mechanical emulsification methods dispersed phase droplets are broken into smaller ones by the hydrodynamic stresses in the continuous phase overcoming the interfacial tension acting to keep the droplet together and round (capillary pressure). Similarly, shear induced droplet detachment or cross flow ME droplet formation has been described in an analogous manner by considering the forces acting on the droplet as it detaches. Once the mechanical shear forces generated by the flowing continuous phase overcome the interfacial tension force the droplet begins to deform and detach. The difference being that in ME the droplet is emerging from a pore and breaking off one by one rather than splitting existing drops into smaller ones.

An alternative and preferred droplet creation mechanism for ME is interfacial tension induced droplet formation, which is also referred to in the literature as spontaneous droplet formation, interfacial tension assisted droplet formation, interfacial tension driven droplet formation, Laplace instability induced droplet formation, or Roof snap-off droplet formation (E. van der Zwan et al. Colloids and Surfaces A: Physicochem. Eng. Aspects 277 (2006) 223-229). Here the term “spontaneous” will be used to describe this type of droplet formation presented below. Sugiura et al. presented in 2001 a mechanism for spontaneous droplet formation described by considering the Gibbs free energy of the system. A droplet was deformed by the rectangular geometry of a micro-channel causing it to have a disc-like shape, which is unstable from Gibbs free energy point of view, since it has a much greater interfacial area than a sphere of equivalent volume. Furthermore it was found that the geometry of the micro-channel played a critical role in droplet formation since it is essential that the droplet is deformed from its spherical, lowest energy shape. This type of droplet deformation does not solely take place in micro-channel emulsification, but is also observed in SPG (Shirasu porous glass) ME and in arrays of straight through holes in silicon plates. The determining factors are the affect of pore structure on the deformation of the dispersed phase droplet and the ability of the continuous phase to enter the pores assisting droplet's pinch-off. Spontaneous droplet formation is preferable because droplet size distributions are typically much narrower and generally have a coefficient of variation under 5% and thus are considered mono-dispersed emulsions. Furthermore the need of cross flow for droplet detachment is eliminated.

At present, membranes, such as tubular membranes of micro-porous glass (MPG), Shirasu porous glass (SPG), ceramic α-Al₂O₃, and ceramic α-Al₂O₃ coated with titanium oxide or zirconium oxide have been used in ME processes. These types of ceramic membranes are available in a range of pore sizes (typically 0.02 to 20 μm) and may be hydrophobic or hydrophilic. These membranes have been successful at producing emulsions with narrow droplet size distributions despite the fact they were originally developed for separation processes. For this reason ceramic membranes are not optimal for ME, due to too high pressure drop over said membranes, caused by the tortuous structure thereof. Many ceramic membranes, such as SPG membranes, do not tolerate high pH and special methods need to be used as not to leach the sintered ceramic matrix. Another drawback with ceramic membranes is that they have a porosity that is much higher than necessary (around 50 to 60%). This results in only the largest pores being active. Furthermore, ceramic membranes have a very tortuous pore structure, which in combination with its thickness can complicate cleaning. As tubular membranes with a typical tube diameter of 7 mm they are also space demanding. If there is not a high enough aspect ratio in the pore structure they are very dependent on cross-flow for good emulsification results. Moreover, cross-flow causes pressure drop which in turn changes the effective trans-membrane pressure along the membrane tube, i.e. droplets are forming at different rates at different axial positions along the membrane tube. This limits the possible dimensions of membrane tubes or channels.

ME methods using membranes in which the pore size and spacing is designed have up until now only been performed using micro-machined silicon chips or small scale membranes produced by micro-lithography. These membranes which are frequently referred to as micro-sieves or micro-channels, have the advantage of being able to choose the exact pore size and shape, which could be formed to promote spontaneous droplet detachment. However, as ceramic membranes they are accordingly very expensive, hard to scale up, can be problematic to clean, and due to the manufacturing technology they rely on, the area of these membranes (the size of a single membrane unit) is limited to tens of cm². Furthermore, membranes, micro-sieves and micro-channels which are silicon based are susceptible to oxidation which can in turn change the membranes wetting properties and thereby diminishing its function. Other types of micro machined membranes rely on the formation of precisely shaped pores in said materials by laser drilling, cutting, boring, etc. Thus, it is very difficult to achieve exactly the proportions sought, and the manufacturing methods mentioned are time consuming and accompanied by the use of costly materials and equipments.

An alternative to ceramic membranes and micro-sieves would be track etched membranes. Track etched membranes can be produced continuously at a fraction of the cost of the above mentioned membranes and have straight uniform pores which greatly alleviates cleaning problems. A study using track etched polycarbonate membranes for emulsification has been published in the literature (Kobayashi et al. Colloids and Surfaces A, 207 (2002) 185-196). However the droplet size distribution was large having a coefficient of variation ranging from 20 to 50%. Furthermore the droplet size as also greatly affected by the cross flow of the continuous phase, the size reduced by 6 fold when increasing the cross-flow from 0.1 to 0.35 m/s. This indicated that the droplets formed by shear induced droplet detachment, and is supported by the fact the pores are round (10 μm diameter) and the membrane was thin relative (10 μm thick) to the pore diameter. For this reason spontaneous droplet was not enabled by the pore geometry.

In respect of the manufacturing methods of membranes for emulsification processes US 2004/0213985 describes a prior art method. US 2004/0213985 discloses a membrane comprising a support layer and active layers, wherein the support layer is located between the active layers. US 2004/0213985 also describes stretching of a membrane, but only for controlling the size and distribution of the pores. Nothing is mentioned about shaping the pores in an predefined, advantageous way, such that droplets form spontaneously with out the need for the drag of the cross flow to detach them.

US 2004/0152788 discloses a method for manufacturing emulsions of fluorinated liquid droplets in water. In US 2004/0152788 it is disclosed that it is suitable to manufacture such emulsions with polymer membranes, which have been manufactured through stretching. Such membranes are disclosed in U.S. Pat. No. 5,476,589. However, the stretching referred to in U.S. Pat. No. 5,476,589 is performed to affect the porosity of the membranes to such extent that pores are obtained, which pores may be used in the manufacturing of emulsions. No pores are present before the stretching of the membrane. Thus, U.S. Pat. No. 5,476,589 fails to disclose how to modify pores to exclude the need of cross-flow in the manufacturing of emulsions with membrane technology.

The present drawbacks of membrane emulsification membranes are difficulty to produce membranes with a designed pore shape, which promotes spontaneous droplet formation in a cost effective way on a large scale. By manufacturing a membrane with a designed pore shape to eliminate the need for cross-flow, out of a cleanable, durable, and inexpensive material the numerous advantages of membrane emulsification can be realised on an industrial scale which is commercially viable. Another advantage would be to realize the possibility to manufacture a new generation of emulsions, comprising microorganisms or other substances prone to degrade under the affection of temperature increase or shear forces, since the shear forces in the membranes of today are too large for enforcing the manufacturing of such emulsions.

Hereby, a manufacturing method would be advantageous, which manufacturing method not is accompanied with time consumption and/or costly materials and equipments, and an improved manufacturing method of a membrane, and a membrane obtained thereof for droplet formation by ME allowing for a narrow droplet size distribution, high capacity, flexibility, space and energy savings, cost effectiveness, durability, cleaning capability, and the possibility to use said membranes as disposable membranes, due to the low manufacturing costs, and also emulsions obtained by using such membranes, which emulsions could comprise microorganisms or other substances sensitive to temperature increase or shear forces.

### SUMMARY OF THE INVENTION

Accordingly, the present invention seeks to mitigate, alleviate or eliminate one or more of the above-identified deficiencies and to provide an improved membrane for the production of emulsions of the kind referred to. For this purpose a manufacturing method is characterized by stretching said membrane material, provided with at least one pore with a first shape, such that a second shape of said at least one pore is obtained, and a membrane is characterized in that said membrane is stretchable. Advantageous features of the invention are defined in the dependent claims.

### BRIEF DESCRIPTION OF THE DRAWINGS

These and other aspects, features and advantages of which the invention is capable of will be apparent and elucidated from the following description of embodiments of the present invention, reference being made to the accompanying drawings, in which

FIG. 1 illustrates the commonly known principle of membrane emulsification, wherein the cross-flow detaches droplets at the pores of a membrane;

FIG. 2 illustrates shear induced droplet formation in membrane emulsification where the droplet necking occurs outside the pore, here the shearing (or drag) generated by the cross flow acts to detach the droplet;

FIG. 3 illustrates spontaneous droplet formation, assisted by the geometry of the pore, where droplet necking occurs inside a pore;

FIG. 4 illustrates, according to an embodiment of the invention, membrane stretching in a controlled manner until pores obtain a correct shape to allow spontaneous droplet formation, where the resulting droplets are having a predetermined droplet size;

FIG. 5 illustrates the track-etching process and according to an embodiment of the invention how subsequent processing steps for membrane stretching could be performed;

FIG. 6 illustrates a method, according to an embodiment of the invention, for High Capacity Membrane Emulsification;

FIG. 7 illustrates a method, according to an embodiment of the invention, for High Capacity Membrane Emulsification;

FIG. 8 shows the unstretched sheet in a magnification of 10,000 times according to one embodiment of the present invention;

FIG. 9 shows the stretched sheet in a magnification of 10,000 times according to one embodiment of the present invention;

FIG. 10 illustrates the stress strain relationship of film while stretching PET film at 160° C.;

FIG. 11 illustrates a flow-chart of a method of manufacturing emulsions according to one embodiment of the present invention;

FIG. 12 illustrates the opaqueness of produced emulsions according to an embodiment of a comparative test;

FIG. 13 illustrates a magnification of some of the emulsions in FIG. 12; and

FIGS. 14a and 14b shows images of emulsions obtained by prior art and obtained by the use of a membrane according to one embodiment of the present invention, respectively.

### DETAILED DESCRIPTION OF EMBODIMENTS

By using membranes obtained by the manufacturing method according to the present invention the prior art problem of pressure drop along the module is eliminated, and droplet formation does not require cross-flow, which in turn allows for a wider range of design solutions. By solving the problems of prior art solutions regarding cost, scale up, and durability, new products in various fields of application can be commercially viable.

The production of micro-capsules and micro-spheres is an emerging technology which has received a decisive impulse as a consequence of the development of highly mono-disperse membrane emulsification techniques. Examples of applications, which have originated by using membrane technology where particles require sizes and degree of mono-dispersity that is difficult to reach by other conventional techniques are (i) encapsulation of anti-cancer drugs in drug delivery systems that, after injection into the blood, are slowly released into the targeted organ, (ii) preparation of porous beads to be used as packing beads in gel permeation chromatography or as carriers, (iii) preparation of micro-capsules with metal oxides encapsulated to be used as pigments for cosmetics, paints, and photo-oxidation catalysts for waste water treatment, (iv) encapsulation of antibodies, such as immunoglobulin found in egg yolk, and bacteria, such as probiotic bacteria, for preservation of therapeutic effect, and stability, respectively.

It shall be noted that the membranes produced by the present invention allow for a better suitability in respect of encapsulating active components, such as chemotherapy drugs, having a high toxicity, since the membranes according to the present invention may be single use membranes, thus eliminating the need for regeneration at high temperatures, washing, re-use, etc. of membranes used for such encapsulation. In this case size and size distribution are very important.

Furthermore, it shall be noted that the membranes of the present invention are better suited to manufacture emulsions according to (i), (ii), (iii), and (iv) above, for the reason that there is no requirement of high shear stresses or cavitation associated with high pressure homogenisers, whereby the encapsulation may be maintained in a better form, since no risk of disturbance of the encapsulation due to said cross-flow.

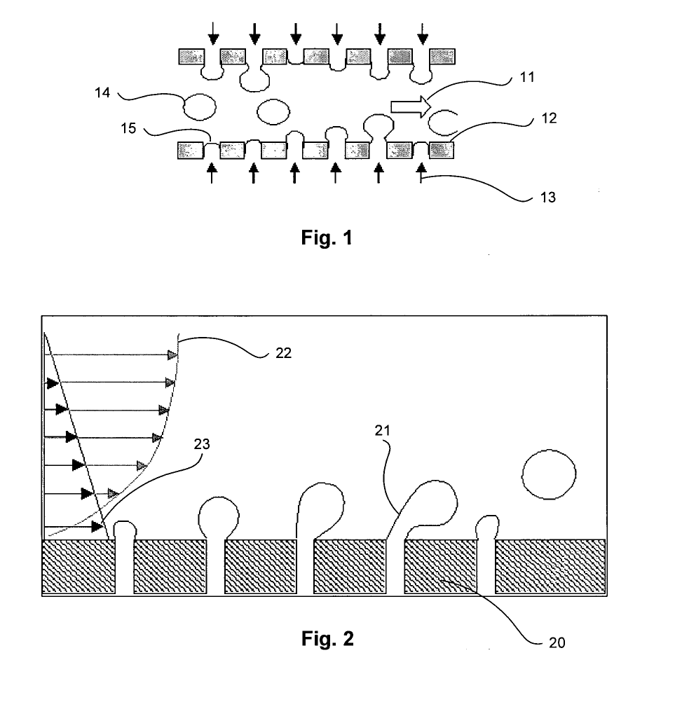

FIG. 1 illustrates cross-flow membrane emulsification, in which the continuous phase 11 flows tangentially to the membrane surface 12 and the dispersed phase 13 is pressed through the membrane. Droplets 14 of the dispersed phase 13 are formed at the openings 15 of membrane pores, and are continuously swept away by the flowing continuous phase 11.

FIG. 2 illustrates the mechanism referred to as shear induced droplet formation, where in a droplet necking (or pinch-off) 21 outside the pores of a membrane 20 can be observed. Droplet necking is the break-up or pinch-off of a droplet from the dispersed phase extruded from a membrane pore or micro-channel. The shear profile 23 and the velocity profile 22 of the continuous phase are also shown.

ME is more energy efficient than conventional emulsification technologies because the droplets are breaking away from the pore at the wall, where the shear stress generated by cross-flow is the highest. Cross-flow, in this respect, is intended to be interpreted as a continuous phase flow in a membrane which functions to detach the droplets originating from the pores in the membrane wall. Again as with shear break-up the droplets are deformed by the flowing continuous phase and once a critical deformation is reached they detach. The efficiency of membrane emulsification can be further improved by eliminated the need of cross-flow for droplet detachment through using a pore design which enabled spontaneous droplet formation.

There are two main geometric aspects to consider when designing the pore shape in a membrane, the aspect ratio and the pore length, such as the membrane thickness, respectively. The aspect ratio, i.e. the ratio between the major axis (2a direction) and the minor axis (2b direction) of the pore, can be used to indicate if spontaneous droplet formation is possible. The critical threshold value of 3 has been observed in empirical studies with straight through micro channels for enabling spontaneous droplet formation. The explanation of this phenomenon is that the pore itself has “pre-deformed” the droplet. If the pore is oblong, the dispersed phase inside the membranes will be constrained by the pore's geometry and this case the droplet is deformed by extrusion through pores. Another observed benefit to pores with high aspect ratios is that they allow for continuous phase to enter the pore at the ends with the highest curvature, i.e. the maximum of the major axes, at 2a shown in table 1. This feature also promotes droplet necking inside the pore.

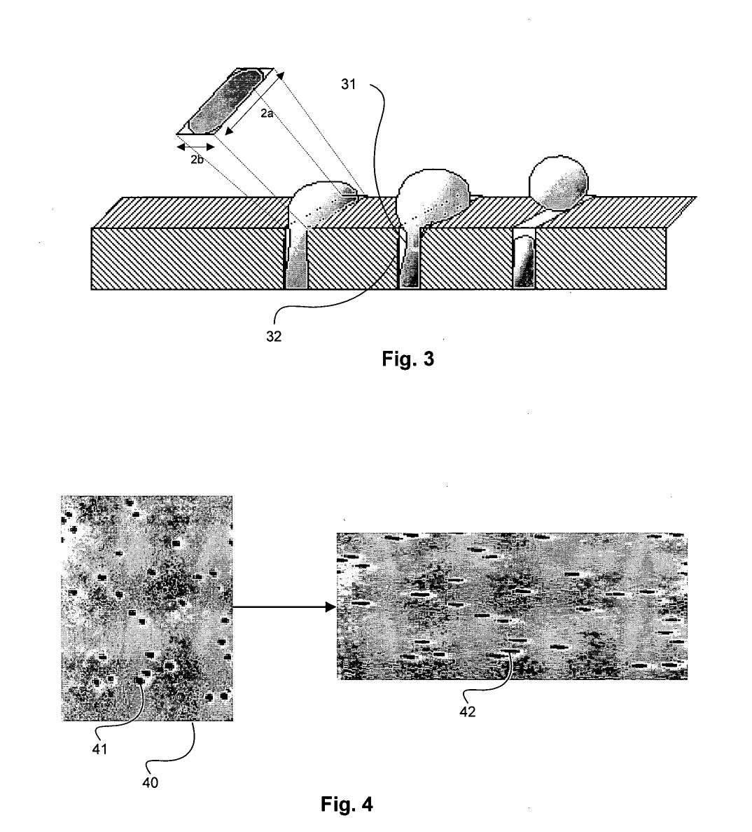

FIG. 3 illustrates geometrically assisted spontaneous droplet formation where droplet necking 31 occurs inside a pore 32 where 2b is the minor axis of the pore, such as the breadth, and 2a is the major axis of the pore, such as the width, and the aspect ratio a/b>critical threshold value.

If the aspect ratio is less than the critical threshold value, further deformation of the droplet via attaining an unstable volume or by the action of shear and drag forces in the continuous phase outside the pore is required, droplets grow and detach through a shear induced break-up, as can be observed in FIG. 2.

The location of droplet necking can explain why markedly different emulsification results are obtained depending on the shape of the pore. Pores with aspect ratios greater than the critical threshold value, produce regularly sized droplets (coefficient of variation less than 4%) because necking occurs inside the pore. Rounder pores with aspect ratio less than the critical threshold value produce poly-disperse droplet size distributions because the necking takes place outside the pore exposed to the flow of the continuous phase. This flow, although often laminar at these dimensions, is still rather chaotic. Conversely, when the necking takes place inside the pore, it is determined by the pore's geometry that is constant and no cross-flow is required.

The following description focuses on embodiments of the present invention applicable to a method for manufacturing a membrane for membrane emulsification, a membrane obtained by said method, a device, comprising said membrane, and a method for membrane emulsification, and more particularly to a computer readable medium for controlling said method. However, it will be appreciated that the invention is not limited to this application but may be applied to many other technical aspects, which will be obvious for the person skilled in the art.

The invention introduces a method of manufacturing a membrane which results in substantially lower membrane costs, substantial energy savings, size distribution accuracy of produced emulsion droplets, increased capacity, flexibility, space savings, cost effectiveness, durability, cleaning capability, and the ability to create new products and processes which are currently impossible using today's conventional emulsification technology. The emulsification technology this membrane makes feasible will be referred to as High Capacity Membrane Emulsification (HCME).

The inventors of the present invention have derived relations between the droplet size, pore length, such as membrane thickness, and aspect ratio to be used as guidelines be able to determine a specific pore size and shape of a membrane for producing an emulsion with a desired droplet size, see table 1 and table 2 below. The realisation of HCME membranes is not limited to the use of these equations but could also be achieved through practical, empirical, experimental methods.

If one were to stretch a circular pore one will obtain a shape that is elliptical (see FIG. 4), similarly stretching a square pore will obtain a rectangular shape. In table 1 below is provided relations for both the elliptical case and the rectangular case. However the idea of increasing the aspect ratio of an existing membrane pore is not limited to these shapes, they are provided as examples.

It is possible to create pores of other shapes from a suitable membrane material e.g. triangular, lenticular, hexagonal etc.

Depending on the deformation characteristics of the membrane, the pore's cross-sectional area may increase (caused by non-linear strain, shrinkage etc.) This is a measured property of the membrane material and processing conditions during stretching. This phenomenon, designated as the “stretch constant”, Ψ is a measured property of the membranes being stretched. A theoretical limit for this would range from 1/α to α, where α is the aspect ratio, however empirical evidence puts this value in the range of 0.8 to 1.8. If the pore area is constant during stretching then Ψ=1.

Moreover, the minimum pore length of an elliptical, or rectangular shaped pore, to hold the entire volume of the droplet and to offer the opportunity to the forming droplet to neck inside the pore, can be described by Lₚₒᵣₑ, (Eqn. 8) in table 1. However, the realisation of HCME membranes is not limited to the use of these equations but could also be achieved through practical, empirical, experimental methods. The membrane, after stretching may have a thickness of that is greater than the minimum pore length. Due to the principle of conservation of mass, if the membrane is incompressible then stretching in one direction reduces the dimensions in the other two. If stretching the membrane increases the breadth as in FIG. 4, it may reduce the thickness, this will not exceed the applied strain and therefore the Lₚₒᵣₑ should be compared to Z_{new} in Eqn. 10 in table 2.

TABLE 1
Specifications and Equations for HCME design

| Shape | Ellipse | Rectangle |
|---|---|---|
| Geometry | 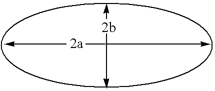 | 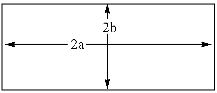 |
| Aspect ratio, α | $α ≡ \frac{a}{b} \qquad Eqn . 1$ | |
| Pore Perimeter | perimeter of an ellipse can be computed using the Gauss-Kummer series: $\begin{matrix}Perimeter = π ( a + b ) ( 1 + \frac{1}{4} h + \frac{1}{16} {h}^{2} + \frac{1}{256} {h}^{3} + … ) & \\ h ≡ {( \frac{a - b}{a + b} )}^{2} & Eqn . 2 a\end{matrix}$ | The perimeter of a rectangle: Perimeter = 4a + 4b Eqn. 2b |
| Pore Area | cross-sectional area of | cross-sectional |
| | an elliptical pore can be | area of a |
| | calculated as: Area = π· a · b | rectangular pore |
| | Eqn. 3a | can be calculated |
| | | as: Area = 2a · 2b |
| | | Eqn. 3b |

| | |
|---|---|
| Hydraulic Radius, Dₕ | ${D}_{h} ≡ \frac{4 \cdot Area}{Perimeter} \qquad Eqn . 4$ |
| Droplet Diameter, D_{drop} | The size of the droplet (diameter) which is produced using a pore with an aspect ratio > 3 is estimated using: ${D}_{drop} = \frac{2 \cdot {D}_{h}}{\vert cos θ \vert} \qquad Eqn . 5$ θ is the 3 phase contact angle describing the wetting properties of the membrane and two phase system. |
| Droplet volume, V_{drop} | ${V}_{drop} = \frac{4}{3} {π ( \frac{{D}_{drop}}{2} )}^{3} \qquad Eqn . 6$ |
| Preferred membrane porosity, κ | The porosity is expressed as pores per cm², then the preferred porosity is calculated as: $κ = \frac{4}{{πD}_{drop}^{2} {10}^{4}} \qquad Eqn . 7$ |
| Preferred membrane thickness Lₚₒᵣₑ | ${L}_{pore} = \frac{{V}_{drop}}{Area} \qquad Eqn . 8$ |

TABLE 2
Equations and definitions for Stretch Specification

| | |
|---|---|
| Amount of Stretching Strain SS required for a round pore to achieve a certain aspect ratio α , i.e. the relative change in membrane Δx/x | SS = \sqrt{αψ} − 1 Eqn 9. |
| The stretched membrane has a new thickness, Z_{new} which is smaller than the original, Zₒ. | ${Z}_{new} = {Z}_{o} - {Z}_{o} ( \frac{SS}{SS + 1} ) . \qquad Eqn . 10$ |

Planar uniaxial-extension is the preferred type of stretching for making HCME membranes because the membrane would not become thinner, rather would decrease in breadth, i.e. the minor axis, (2b direction) and thus the thickness would remain constant. In most stretching processes change in thickness occurs, the degree of which needs to be determined empirically for the particular stretching method and membrane material being used. However, the maximum decrease in thickness can be estimated by Eqn. 10 in table 2.

The desired porosity (pores per cm2) of the membranes manufactured according to below should not exceed the value (pores per cm²) obtained by Eqn. 7 in table 1. The reason being that each droplet forming from a pore needs a certain distance from its nearest neighbouring pores to prevent the droplets from coalescing or interacting with each other and negatively affecting the droplet size distribution. Beyond the total porosity, the placement of the pores with respect to each other is important. In track etched membranes pores are randomly distributed, however it would be obviously preferable to have a pattern of pores which maximised the usage of membrane area for droplet generation.

In a first embodiment of the invention, according to FIG. 4, a membrane 40, suitable for spontaneous interfacial tension assisted droplet formation by HCME, is manufactured. In this manufacturing method a suitable material is first provided. A suitable material may for example be a track-etched polymeric material, such as polycarbonate (PCTE), polyester (PETE), or polyamide.

Polymeric membranes are thinner than ceramic membranes, have a lower hydrodynamic resistance, resulting in lower pressure drop, and are less tortuous in structure (in the case of Track Etched Membranes they are straight cylinders). An advantage of this embodiment is that the flushing and rinsing of the membrane is significantly facilitated. Furthermore, the manufacturing cost is much lower, and in contrast to ceramic membranes, theses membranes are available as rolls or flexible sheets and are non-brittle.

The suitable material, such as a polymeric material, is provided with at least one pore. It is of course of great advantage to provide said membrane material with a plurality of pores, by for example track etching, the preferred porosity of which being described above.

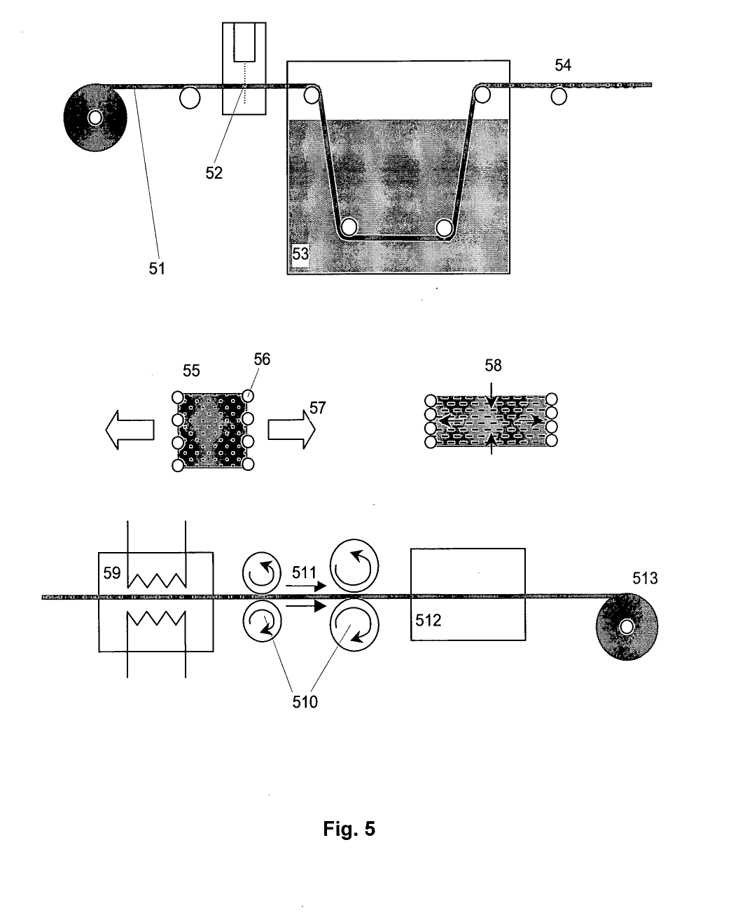

One suitable membrane material has an original pore geometry (i.e. the pore shape in the un-stretched membrane material) that is an assembly of parallel cylindrical shaped pores of uniform diameter as seen in FIG. 4, 40. Such structures can be obtained by track etching. In this method, schematically depicted in FIG. 5, a polymeric membrane material or foil 51 is subjected to high energy particle radiation applied perpendicular to the membrane 52. The particles damage the polymeric material and create tracks. The material then immersed in a concentrated acid or alkaline bath 53 where the polymeric material is etched away along these tracks to form uniform cylindrical pores with a narrow pore size distribution through the membrane 54. Pore sizes range from 0.02 to 10 μm with a maximum porosity of 10% and a typical thickness up to 20 μm. Porosity is determined by the radiation exposure time while diameter is determined by the etching time. The thickness is limited by the energy of the particle radiation. This type of track etched material is suitable for stretching to create pores with an aspect ratio that enables spontaneous droplet formation.

Thereafter, said membrane material is stretched. The stretching of said membrane material is performed until a desired shape, according to above, has been obtained. This stretching may be controlled or regulated in a suitable manner, such as by a computerized stretching device. It is also possible to pre-treat, such as by temperature pH or chemical treatment, said membrane material before said stretching, to thereby facilitate said stretching or minimize the force needed in said stretching. When the membrane material has been provided with pores of a desired shape the structure of said membrane material may be fixated, such as by temperature pH or chemical treatment. Thereby, a membrane for emulsification, such as HCME, has been obtained. In respect of “track etched membranes” a temperature in the interval 80 and 160° C. may be used. Of course, other temperatures may be used, depending on what material is used as the material of the membrane. The important factor is only that the membrane will be affected by the temperature in such way that it may be stretched. In general this increase of the temperature will exceed the glass transition temperature but not exceed the melting temperature of the material, whereby the material not will suffer from brittleness or melt to a liquid. It is within the knowledge of the skilled artisan to determine what temperature to use in respect of the material of the membrane.

In one embodiment one part of said membrane material is optionally pre-treated, followed by stretching, and then fixated, to obtain a first shape of the pores, while another part of the membrane is optionally pre-treated, stretched, and then fixated, thereafter, to obtain a second shape of said pores. Thereby, a membrane has been provided, which membrane may produce droplets of different sizes.

In another embodiment of the invention, the membrane is capable of being stretched differently in different parts of the membrane, resulting in at least two specific kinds of pore sizes and shapes are obtained. In this way the resulting emulsion from only one membrane may comprise droplets with more than one droplet size. Hence, one emulsion can be used for multiple purposes.

FIG. 5 depicts stretching which can be accomplished by fastening appropriate grips 56 to a rectangular sheet of membrane material 55, then applying a physical or chemical treatment to increase the membrane material's susceptibility to deformation, then applying a stress or strain rate in the direction of 57 that deforms the membrane material to achieve the a pore shape which enables spontaneous droplet formation 58. The deformation may be set by physical or chemical treatment. This procedure could be accomplished, for example, in an Instron Universal Testing Machine using appropriate grips and heating chamber, or using an Inventure Laboratories Inc. Biaxial Film Stretcher, with planar mode. Methods to stretch films are for example described in U.S. Pat. No. 6,540,953, which methods hereby are integrated as examples of stretching methods. These methods, in contrast to the present invention are for the modification of filtration membranes and do not consider aspect ratio, pore length and porosity in terms of emulsion production.

Membrane stretching could also be achieved continuously; as either an additional process step in an existing track-etching membrane manufacturing process or as a stand alone process performed on a suitable membrane material. This operation is depicted schematically in FIG. 5. The suitable membrane material, such as a track etched polymeric membrane 54 is subjected to a suitable physical or chemical treatment 59 to increase the membrane material's susceptibility to deformation, then the membrane passes between 2 sets of rollers 510 of which one set rotates faster than the other thereby drawing out and stretching 511 the membrane material to achieve the a pore shape which enables spontaneous droplet formation, and then the deformation may be set 512 by either changing the temperature by annealing and then cooling or by exposing the membrane to a chemical treatment to harden it again (e.g. removing or changing solvents, changing the ph etc.) The final HCME membrane then can be collected on a roll 513, ready to be cut to size for use in a suitable membrane module. The use of rollers to draw polymeric materials is a standard operation in plastic film processing and is described in plastic film technology texts and works for films up to several mm in thickness. It is however essential that the proper stretch amount is decided based upon obtaining pore shape and length, which enables spontaneous droplet formation.

According to FIG. 4, a membrane 40, suitable for spontaneous droplet formation for HCME, is provided; said membrane is capable of being stretched such that the pores 41 of said membrane obtain a shape and size 42 corresponding to a predetermined droplet size, without needing cross flow to detach said droplets. The stretching of said membrane may in one embodiment be performed in a controlled manner.

In an embodiment, the membrane is a flexible flat sheet of suitable membrane material, which has been stretched to obtain a pore shape to enable spontaneous droplet formation, mounted in a spiral wound module in which the membrane is wrapped with spacers on either side in order to allow a dispersed phase flow through the membrane generating droplets into a continuous phase on the other side of the membrane. Standard spiral wound modules have low initial investment costs and low replacement costs compared to tubular membranes. Spiral wound modules have a typical membrane packing density of 300 to 1000 m²/m³ compared to 100 m²/m³ for tubular ceramic membranes. It is also possible to mount the membrane in a plate and frame membrane module, or in a suitable membrane holder, which both are known to the person skilled in the art.

In an embodiment, the membrane is a flat membrane material with a pore shape suitable for spontaneous droplet formation, used in a plate and frame module in which the membrane is stacked with spacers on either side in order to allow a dispersed phase flow through the membrane generating droplets into a continuous phase on the other side of the membrane. Standard plate and frame modules have a typical membrane packing density of 100 to 400 m²/m³.

In an embodiment, the membrane is a membrane material with a pore shape suitable for spontaneous droplet formation and is used in a suitable holder, rig, or module fit for the intended use for making emulsions using said membrane.

In another embodiment the hydrophobic or hydrophilic nature of the membrane (i.e. wetting properties described by the contact angle) can be modified by surface treatment on the membrane. The surface of the membrane will affect the formation of droplets during the emulsification process.

According to another embodiment of the invention, said stretching of the membrane is controlled by computer program. This computer program is then provided with a calculating means for calculating a pore size and pore shape corresponding to the desired droplet size, by taking into account the aspect ratio of said membrane and membrane thickness.

In an embodiment this computer program utilizes the description of droplet size according to Eqn. 5 in this respect. Thereafter, this computer program may send this information to a stretching means, converting this information into suitable mechanical stretching, whereby a suitable aspect ration and thereby a suitable droplet size is obtained.

In another embodiment Eqn. 5, Eqn. 7 and Eqn. 8 are used to determine the pore size, membrane porosity, the pore shape and/or membrane thickness.

According to another embodiment of the invention, a device for stretching a membrane, suitable for spontaneous droplet formation for use in HCME, is provided. Said device comprises a termination means for terminating the stretching when the corresponding pore size and/or pore shape is reached, which in turn corresponds to a suitable aspect ratio.

In an embodiment of the invention the calculating means optimizes the pore size and pore shape of a membrane, by varying the membrane thickness, with a criteria that the aspect ratio≧critical threshold value.

In an embodiment of the invention the calculating means optimizes the pore size and pore shape of a membrane, by using a fixed membrane thickness, with a criteria that the aspect ratio≧critical threshold value.

In an embodiment of the invention the critical threshold value ranges between 3 to 10, such as between 3-9, 3-8, 3-7, 3-6, 3-5, 3-4, 3.1-3.5, 3.8-4.2, such as 3. In a preferred embodiment of the present invention the aspect ratio is selected to be within the interval from 3 to 6. In general the aspect ratio has to be high enough to obtain a spontaneous droplet formation. An aspect ratio over 10 could in principle work, but the membrane would then get unnecessarily thin, due to the stretching.

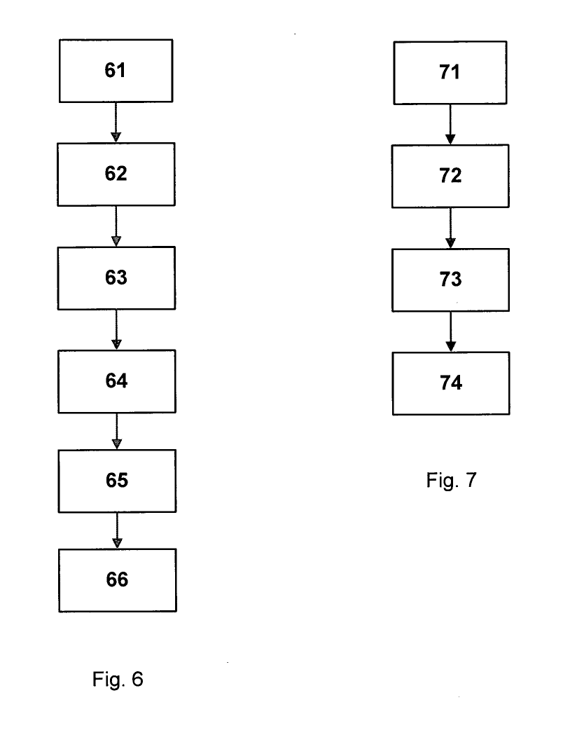

In an embodiment of the invention, according to FIG. 6, a method for creation of a membrane, suitable for spontaneous droplet formation, is provided. The method comprises the following steps, wherein the first step comprises specification of the desired droplet size 61. The desired droplet size may differ depending on the field of application. In the second step, the feasible original membrane pore sizes and final pore shapes after stretching are calculated 62 from the desired droplet size and the physical characteristics of the membrane and constituents, based on the criteria that the aspect ratio exceeds critical threshold value for droplet formation. In the third step the corresponding membrane thickness to enable necking inside the membrane is calculated 63 from the calculated droplet volume, pore size and shape. In the fourth step the maximum porosity of the membrane is calculate based on the desired droplet size 64. In the fifth step a suitable membrane is selected based upon the calculations above 65, and in the sixth step the suitable membrane is stretched 66 until the desired pore size and shape is reached.

In another embodiment of the invention, according to FIG. 7, another method for creation of a membrane, suitable for spontaneous droplet formation for use in HCME, is provided. The method comprises the following steps, wherein the first step comprises specification of the desired droplet size 71. In the second step, a membrane with a specified thickness ensuring necking is selected 72. In the third step the membrane pore size and shape is calculated 73 from the desired droplet size and the specified membrane thickness, based on the criteria that the aspect ratio critical threshold value for droplet formation applies for the calculated pore size and shape. In the fourth step the selected membrane is stretched 74 until the desired pore size and shape is reached.

In another embodiment of the invention, a method for creation of a membrane, suitable for droplet formation by HCME, is provided. By specifying a preferred membrane thickness range (to ensure necking) and desired droplet size, a pore size and shape optimization calculation is performed, based on the aspect ratio critical threshold value, for spontaneous droplet formation.

In another embodiment of the invention a computer readable medium having embodied thereon a computer program, for producing membranes that enable spontaneous droplet formation, for processing by a computer, the computer program comprises a code segment for calculating an optimal pore size and pore shape, based on a desired droplet size, by taking into account the aspect ratio and membrane thickness.

In another embodiment a graphical user interface is provided for designing pore shape and pore size of a membrane, suitable for use in droplet formation by HCME, based on a desired droplet size, thickness of membrane and aspect ratio.

In another embodiment a graphical user interface is provided for designing specific formations of pore shape(s) and pore size(s) of a membrane, suitable for use in droplet formation by HCME, based on a desired droplet size(s), thickness of membrane and aspect ratio.

As the size of the droplets can be designed, the resulting emulsion can be used as a controlled release system. Both oil-in-water and water-in-oil emulsions are possible (depending on the hydrophobic or hydrophilic nature of the membrane), as is the ability to form double emulsions.

By using spontaneous droplet formation the prior art problems of pressure drop along the module are eliminated, which in turn allows for a wider range of design solutions.

Applications and use of the above-described embodiments according to the invention are various and include exemplary fields such as, uniform silica hydro gel beads, and polymer micro-spheres, Oil in water emulsions (especially for heat or shear sensitive ingredients), Water in oil emulsions (alginate beads for HPLC, functional margarine, pro-biotics), Small droplets (injectable medicines for cancer treatment, LCD spacers, catalysts), double emulsions (controlled release systems, topical creams, fat-replacers), foaming (foods, consumer products), Micro-encapsulation of sensitive ingredients to prevent oxidation and flavour release, Mono-dispersed droplets (medical studies, stable emulsions, controlled release), Liquid-liquid contactors (removal of off-flavours in edible oils, extraction). Another interesting application of HCME includes emulsification of oil containing a dispersed solid (e.g. a biologically active substance). In addition a HCME process can also be performed at an elevated temperature during droplet formation followed by a subsequent step to lower the temperature of the resulting emulsion, resulting in a phase transformation of the product (e.g. from a liquid to solid phase to create particles)

Mono-dispersed emulsion droplets in the size range of tens of nanometres have enormous potential in delivering medicine into the human body via the blood or lungs. Mono-dispersed emulsion droplets can also be used as colloidal carriers systems, and or solidified to create solid lipid nano particles. ME has the advantage over conventional emulsification technologies for making small, mono-dispersed droplets in that the processing conditions are much more gentle, there is low shear, and significantly less energy dissipated as heat.

Mono-dispersed droplets, which are used in making polymeric micro-spheres, have applications in the area of controlled release, drug delivery, and encapsulation of proteins, enzymes, peptides, and living cells for therapeutic or biotechnical applications. As well as in the production of Ca-alginate and starch micro-spheres as carriers, or polymer particles for use in solid phase extraction in for example in environmental remediation or laboratory sample preparation.

Many functional ingredients, such as fat-soluble vitamins, essential oils etc, which would otherwise easily oxidise, can be entrapped in an inner phase of a double emulsion yielding longer shelf life and higher activity. Other functional compounds such as plant extracts and medicines can be extremely bitter. By utilizing the method of the invention these healthy ingredients can be “hidden” in an internal emulsion in a double emulsion that will be not released in the mouth, but adsorbed during digestion. ME is particularly well suited for making double emulsions since droplet are being formed one by one by extrusion through the pore rather than by the breaking of larger droplets, which in turn can lead to the leaking of the internal phase into the continuous phase.

Due to the low shear stresses and mild processing conditions by utilizing the invention shear sensitive materials can be incorporated.

Remove off-flavours from edible oils at low temperatures. Several natural oils such as rapeseed and fish oil have off-flavours that need to be removed. By using a two-step ME process the oil can be dispersed into micron sized drops, allowing a rapid diffusion of the off-flavour compounds into the continuous water phase, oil drops are then re-coalesced and collected in a separator. This process gently cleans the oils at low temperatures to improve flavour without heat damage to the product.

The energy savings by using ME instead of conventional mechanical emulsification technology increases as droplet sizes decrease. It is also possible to make very small emulsion droplets, even reaching nano-scale dimensions via ME.

By using track etched polymeric membranes such as polycarbonate (PCTE), polyester (PETE), or polyamide, the membrane costs can be reduced to such an extent that HCME membranes could be used once and disposed of rather than cleaning for reuse. This is greatly advantageous for the production of biologically active, hazardous, or infectious substances or processes which involve the use of dangerous, toxic or carcinogenic substances where it would be preferable to not re-use the membranes.

By using track etched polymeric membranes, stretching them to obtain a suitable pore shape for spontaneous droplet formation, the resulting HCME membranes can be produced as long rolls 50 cm wide (GE Osmomics), this makes the scale up to industrial production feasible, in contrast to ceramic membranes which have surface areas on the order of 5×10−3 m²/tube and micro-sieves surface areas on the order of 2×10−5 m²/sieve. Their small size means that a large number of individual membranes units need to be used in parallel, increasing module costs.

HCME membranes made by stretching “off the shelf” commercially available track etched membrane material can be formed to produce droplets or bubbles ranging from tens of nanometres to tens of microns. This size range can be somewhat enlarged by using custom membranes where the thickness is increased.

If the membrane sheet is not intrinsically hydrophilic, and one wishes to make oil in water emulsions, surface treatment to increase the contact angle can be performed. In this case the membranes may be treated with polyvinylpyrrolidone, such as LUVITEC® K30 from BASF. The PVP treatment may be performed by applying a 1% (by weight in demineralized water) solution of PVP, such as LUVITEC K30, 30%, for 3 minutes. Thereafter, the sheet is rinsed for 1 minute in demineralized water and dried, such as hot forced air drying.

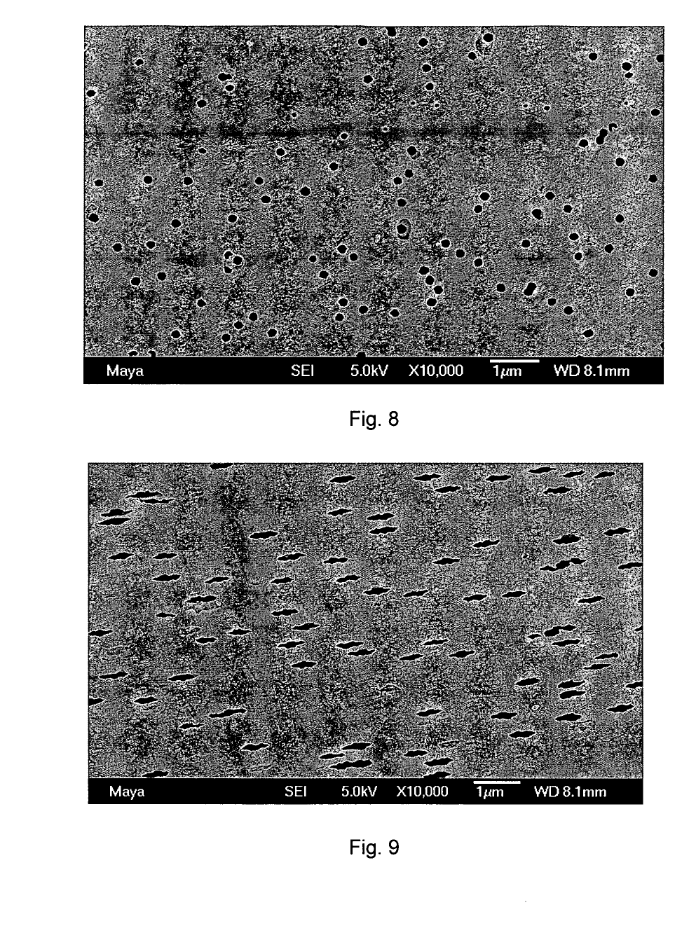

One embodiment of a manufacturing method according to the present invention comprises the use of a 0.2 micron membrane sheet of polyethylene terephtalate (TERPHANE® 40.60, by Toray Plastics Europe S.A.). This sheet had been provided with a pore density of 10⁸ pores/cm². The aspect ratio of the unstretched sheet was approximately 1. FIG. 8 shows the unstretched sheet in a magnification of 10,000 times.

The sheet had the original dimensions of 8.5 cm by 3.5 cm by 50 micron thick.

The stretching conditions were in one embodiment of the present invention selected to comprise a stretching temperature of 160° C.; a preheating time of 40 seconds; a stretching speed 2% per second; a stretching ratio of 1.8 (the amount it increased in length); clip temperature 120° C.; with constant speed and uni-axial, machine direction (MD).

Thus, the sheet was placed in an oven set to 160° C., and the sheet was kept in the oven for 40 seconds. Thereafter the sheet was stretched with constant speed and uni-axial, machine direction (MD), with a stretching speed of 2% per second, while being mounted with clips having a clip temperature of 120° C.

After stretching the dimensions where transformed to 13.3 cm by 2.2 cm by 48 micron thick* (* indicates +/−1 micron due to the resolution of the SEM); a length of 1.55% of original; a width of 62.9% of original; a thickness of 96% of original. The aspect ratio of the stretched sheet was approximately 5+/−1. FIG. 9 shows the stretched sheet in a magnification of 10,000 times. An advantage with the use of the membrane sheet of polyethylene terephtalate was that the thickness was 96% of the original, i.e. that the thickness was almost maintained after the stretching, indicating that the material compensation had occurred in the other dimension, i.e. the width. It is beneficial to maintain the thickness, since it thereby is easier to predict the outcome of the stretched membrane, and the thickness is an important factor when designing a membrane.

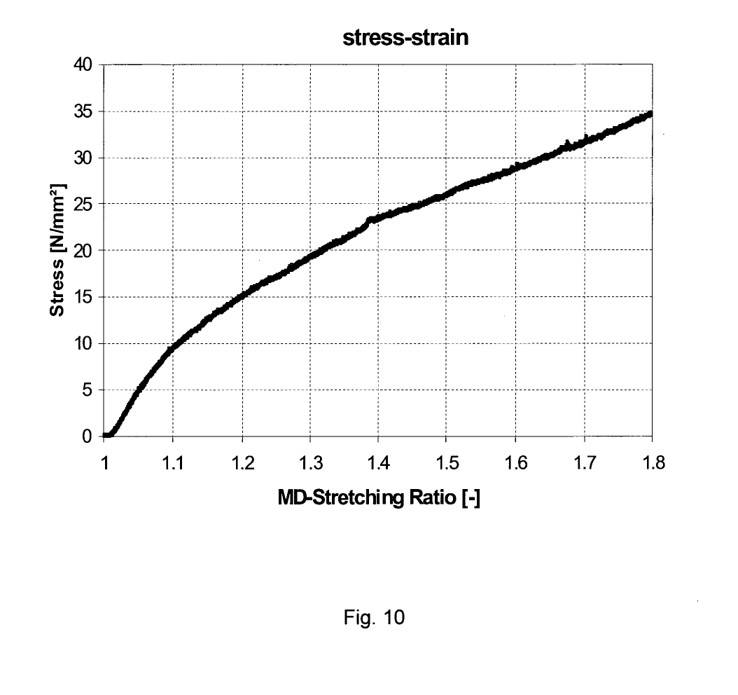

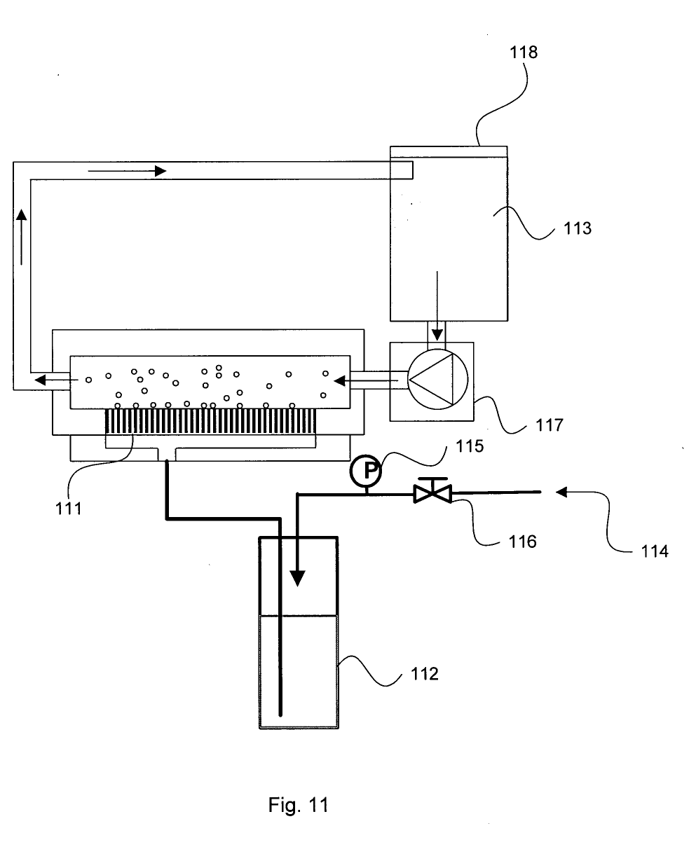

In FIG. 10 the stress strain relationship of film while stretching PET film at 160° C. is illustrated.

FIG. 11 illustrates a process for manufacturing emulsions with the aid of membranes according to the embodiments disclosed above, wherein a membrane is mounted in a membrane chamber 111, such that a dispersed phase 112, such as an oil, is pressed from one side of the membrane to the other side of the membrane. The pressure is applied by the use of a compressed gas 114, such as nitrogen. The pressure from said gas on the dispersed phase may be controlled by a pressure regulator 115 and a valve 116. On the other side of the membrane a continuous phase 113, such as an aqueous phase, is present. Preferably, the continuous phase is recirculated by a pump 117, such as a low shear pump, whereby the concentration of the emulsion is increased by time. When the emulsion has reached a satisfactory concentration the recirculation may be stopped and the emulsion collected.

It is also possible to have an inlet and/or an outlet line (these are not shown) connected to the recirculated stream, which inlet and/or outlet are provided with a valve. Thus, when a satisfactory concentration has been reached these valves may be opened, whereby an emulsion of satisfactory concentration exits the system through the outlet and continuous phase enters the system through the inlet. A buffer chamber 118 may in this embodiment be integrated in the system, to allow a varying volume of the system. Thus, it is possible to have a greater outlet stream than inlet stream, or vice versa, during a time period, to regulate the concentration of the emulsion in the system.

### Experiment

0.2 micron stretched membranes were tested against reference un-stretched membranes.

The system used comprised a continuous phase solution, made out of 990 g de-ionized water and 10 g Tween 20 (Polysorbate 20), i.e. a 1% w/w Tween 20 solution. Tween 20 is a non ionic emulsifier (Mwt. 1225 Da, CMC 4.9*10⁻² mol/m³), used as purchased from Sigma Aldrich CAS [9005-64-5]. The dispersed phase was soy oil, used as purchased from Gylcine max, Fluka, CAS [8001-22-7].

Continuous phase flow rate=19 l/hour. This represents a wall shear stress of 0.016 Pa.

Wall shear stress is calculated using:

Channel geometry 5 mm by 20 mm

Mean velocity U=Q/A

Q=19 liter/hour=5.28*10⁻⁶ m³/s

A=5*10⁻³*20*10⁻³=1.0*10⁻⁴ m²

U=5.28*10⁻² m/s

Viscosity of continuous phase η=1.00*10⁻³ Pa*s

D_{eff} is and effective diameter and taking into account the Reynolds number and channel geometry it is 0.01 (White F. M., Fluid Mechanics 3^{rd} Edition, New York: Mc Graw Hill, 1994, pg 333)

Wall shear stress: 3U*η/D_{eff}=3*5.28*10⁻²*1.00*10⁻³/0.01=0.016 Pa

Wall shear stress is an important parameter for the detachment of droplets when non-spontaneous detachment is occurring, i.e. shear induced detachment from round pores. In this case we are using a very small wall shear stress to illustrate that cross flow is only required to mix the continuous phase and not to shear off the droplets.

In shear induced droplet formation the expected size under the conditions used is 157 micron, calculated using:

$${D}_{drop} = \sqrt{\frac{4 γ {D}_{pore}}{6 {k}_{x} {τ}_{wall}}}$$

where kₓ=1.7 (Peng and William, 1998).

γ=5*10⁻³ N/m

Dₚₒᵣₑ=0.2*10⁻⁶ m

If we achieve droplets less than this figure, then other detachment mechanism, beyond shearing by the continuous phase, are taking place.

Method:

Before and/or between each test the membrane module is disassembled and hand washed using lab dish detergent and hot water. Thereafter it is rinsed with de-ionized water (DIW).

Pumps and tubing are washed by circulation of first hot water, then a 3% w/w solution of Ultrasil 56 (50° C. for 15 min), then hot water (50° C. for 15 min), then DIW (20° C. for 15 min). The membrane is pre-wetted with continuous phase, then the module is assembled and the system is rinsed with DIW, and then with continuous phase (1% Tween 20).

The dispersed phase tank is attached to the pressure line and a small amount of oil is pressed out to remove any bubbles in the tubing. The dispersed phase inlet in the back of the module is filled by hand using a Pasteur pipette to prevent any air bubbled being entrapped behind the membrane. The oil tubing is then attached to the dispersed phase inlet.

The system is filled with fresh continuous phase and the pump is started.

The dispersed phase tank is then pressurized using the gas cylinder and carefully regulated. The pressure applied to the head space in the dispersed phase tank is increased slowly in steps of 0.5 bar at 5 minute intervals until the desired pressure is reached.

The experiment is then allowed to run for the desired length of time.

The run is stopped by closing the valve in the dispersed phase line, and removing the continuous phase from the system by pumping it into the continuous phase tank which is now holding the final emulsion.

The module and membranes are then cleaned as described above, except if the same membrane is to be reused in the following experiment. In this case the system is not disassembled and rinsed using hot water (50° C. for 15 min), DIW (20° C. for 15 min), and continuous phase (20° C. for 15 min).

Test 1 was performed on the reference membrane, wherein the pressure on dispersed phase was 2.5 bars, the volume of the continuous phase was 100 ml, and the run time was 14 hours.

Observations from test 1: resulting emulsion is only slightly more opaque than the original continuous phase indicating very low concentration of oil droplets despite the long run time.

Test 2 was performed on a stretched membrane, wherein the pressure on the dispersed phase was 2.5 bars, the volume of the continuous phase was 70 ml, and the run time was 30 min.

Observations from test 2: In this case a smaller volume of the continuous phase was used, in comparison with test 1, due to the low concentration of oil droplets from test 1. However, the stretched membrane showed to have a much higher flux at the same pressure. After only 30 minutes the emulsions was at least twice as opaque* as the first test.

Test 3 was performed on a stretched membrane, wherein the pressure on dispersed phase was 1.5 bars, the volume of the continuous phase was 70 ml, and the run time was 30 min.

Observations from test 3: In this test the pressure was reduced to 1.5 bar and run for 30 minutes. These conditions were selected to compare its capacity at lower pressure with the reference membrane of test 1. It was found to still be much more opaque* than the reference test 1.

* To account for the fact that different continuous phase volumes were used in test 1 versus 2 and 3 a samples from tests 2 and 3 were diluted with the equivalent amount of continuous phase and photographed with the 14 hour result of the reference membrane as well as the original continuous phase.

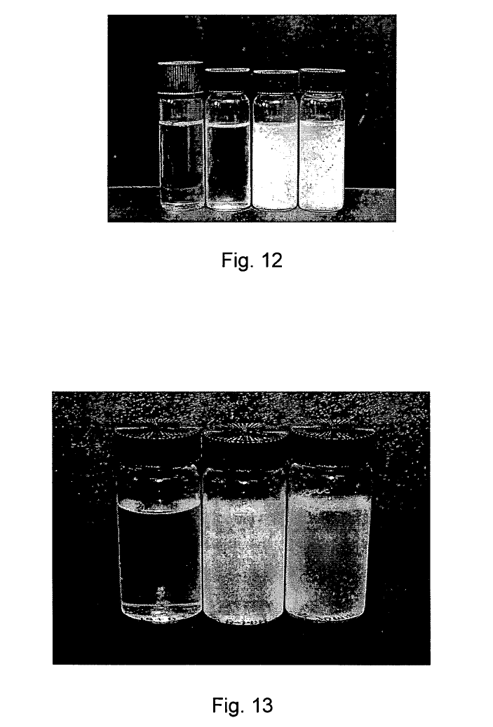

FIG. 12 discloses the opaqueness of produced emulsions. From the left: pure continuous phase; emulsion produced by the reference membrane (round pores) at 2.5 bar after 14 hours; emulsion produced by the stretched membrane (elliptical pores) at 2.5 bar after 30 minutes; and emulsion produced by the stretched membrane (elliptical pores) at 1.5 bar after 30 minutes, are disclosed. Emulsions obtained from the use of stretched membranes were at least twice as concentrated after only 1/28^{th} of the time, indicating an increase in capacity of more than 50 fold. This increase in capacity may be due to that droplets break off more quickly with the help of spontaneous-droplet detachment.

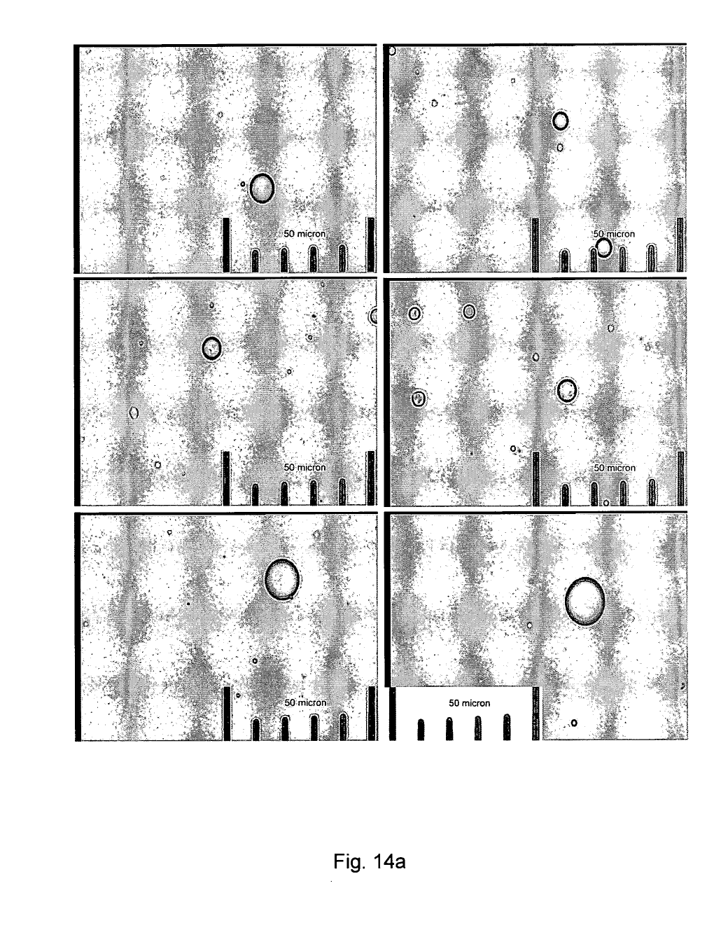

FIG. 13 discloses the opaqueness of produced emulsions in test 1, 2, and 3. From the left: test 1; test 2; and test 3, are disclosed.

Test 4 was performed on a stretched membrane, wherein the pressure on dispersed phase was 1.3 bars, the volume continuous phase was 70 ml, and the run time was 4 hours. The emulsion obtained here from was compared with the emulsion of test 1, i.e. the reference emulsion, with the aid of imaging.

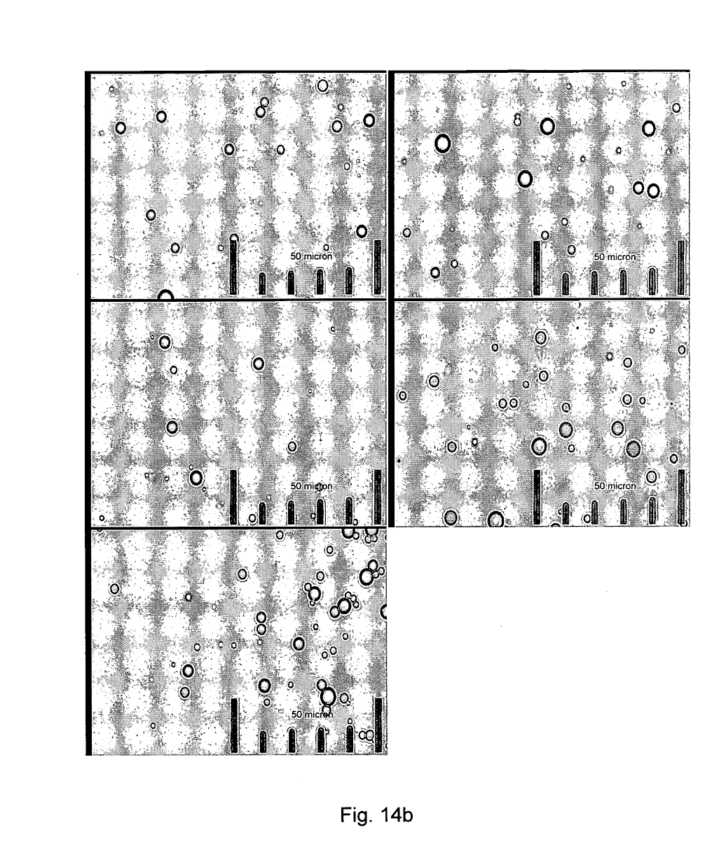

FIG. 14a shows images of undiluted emulsion obtained from test 1, and FIG. 14b shows images of undiluted emulsion obtained from test 4. FIGS. 14a and 14b clearly shows the superior effectiveness of the stretched membrane and quality of the emulsion obtained there from. One shall bear in mind the difference in applied pressure and run time, when evaluating the illustrations of FIGS. 14a and 14b.

An analysis in respect of the droplet size of emulsions obtained from tests with a stretched membrane at 2.5 bar (i.e. test 2), a stretched membrane at 1.3 bar (i.e. test 4) and a reference membrane at 2.5 bar (i.e. test 1) bar was also performed. The stretched membrane at 2.5 bar had a mean of 4.65 micron and standard deviation of 2.10 micron; the stretched membrane at 1.3 bar had a mean of 4.62 micron and a standard deviation of 2.18 micron; and the reference membrane at 2.5 bar had a mean of 7.66 micron and a standard deviation of 5.97 micron. This information is further disclosed in table 3, below.

TABLE 3

| | Mean | Median | S.D. | C.V. | % > 10 | % > 25 | % > 50 | % > 75 | % > 90 |
|---|---|---|---|---|---|---|---|---|---|
| Sample | (um) | (um) | (um) | (%) | (um) | (um) | (um) | (um) | (um) |
| Test 2 | 4.647 | 4.138 | 2.18 | 47 | 7.866 | 5.858 | 4.138 | 2.989 | 2.285 |
| Test 4 | 4.617 | 4.132 | 2.1 | 45.6 | 7.779 | 5.785 | 4.132 | 3.020 | 2.334 |
| Test 1 | 7.659 | 5.503 | 5.97 | 78 | 16.50 | 12.31 | 5.503 | 2.476 | 1.417 |

This analysis was performed on a Coulter LS130, excluding PIDS. Every sample was measured twice with a 10 seconds interval. This means that it is possible to manufacture emulsions with smaller droplet size and approximately half the standard deviation, at many times the production rate. The difference in concentration of the emulsions obtained in test 1, test 2 and test 4 was taken into account when evaluating the droplet sizes of the emulsions.

Although the present invention has been described above with reference to specific embodiments, it is not intended to be limited to the specific form set forth herein. Rather, the invention is limited only by the accompanying claims and, other embodiments than the specific above are equally possible within the scope of these appended claims, e.g. different kind of membranes and/or arbitrary pore shapes than those described above.

In the claims, the term “comprises/comprising” does not exclude the presence of other elements or steps. Furthermore, although individually listed, a plurality of means, elements or method steps may be implemented by e.g. a single unit. Additionally, although individual features may be included in different claims, these may possibly advantageously be combined, and the inclusion in different claims does not imply that combination of features is not feasible and/or advantageous. In addition, singular references do not exclude a plurality. The terms “a”, “an”, “first”, “second” etc do not preclude a plurality. Reference signs in the claims are provided merely as a clarifying example and shall not be construed as limiting the scope of the claims in any way.

1. A manufacturing method of a membrane for membrane emulsification, comprising:
providing a membrane material with at least one pore having a first shape; and
stretching said membrane material, such that a second shape of said at least one pore is obtained.

2. The manufacturing method according to claim 1, wherein said membrane material is stretched in one, two, or three directions.

3. The manufacturing method according to claim 1, comprising fixating said shape of said at least one pore.

4. The manufacturing method according to claim 1, comprising pre-treating said membrane material before said stretching.

5. The manufacturing method according to claim 4, wherein said pre-treating is performed by temperature alteration.

6. The manufacturing method according to claim 5, wherein said temperature alteration is a temperature increase to an interval of 80 to 160° C.

7. The manufacturing method according to claim 1, comprising incorporating said membrane material into a spiral wound module, a plate and frame module, a rig, a module, or a holder.

8. The manufacturing method according claim 1, wherein said stretching is controlled by a computerized stretching device.

9. The manufacturing method according to claim 1, wherein an aspect ratio of said at least one pore is greater than or equal to 3 after said stretching.

10. The manufacturing method according to claim 1, wherein said membrane material includes at least a first pore and a second pore, and a shape of said first pore is different than a shape of said second pore after said stretching.

11. The manufacturing method according to claim 1, wherein said membrane material is made of a polymeric material.

12. The manufacturing method according to claim 11, wherein said polymeric material is a Track Etched flexible membrane material.

13. A membrane obtained by the manufacturing method according to claim 1, suitable for spontaneous interfacial tension assisted droplet formation by High Capacity Membrane Emulsification.

14. The membrane according to claim 13, wherein said at least one pore is substantially elliptical after said stretching.

15. The membrane according to claim 13, wherein said second shape corresponds to a predetermined droplet size.

16. The membrane according to claim 13, wherein the membrane is a polymeric membrane, a Track Etched Polycarbonate Membrane, or of a flexible material.

17. The membrane according to claim 13, wherein an aspect ratio of said at least one pore is greater than or equal to 3 after said stretching.

18. The membrane according to claim 13, wherein said at least one pore has a shape that allows for necking inside said pore.

19. A membrane for membrane emulsification, said membrane comprising:
at least one pore having an aspect ratio of greater than or equal to 3.

20. A method comprising:
using the membrane according to claim 13 to produce an emulsion.
